(19) United States
(12) Patent Application Publication
(10) Pub. No.: US 2011/0001940 A1
(43) Pub. Date: Jan. 6, 2011

(54) LENS BARREL SHIFT MECHANISM AND PROJECTOR

(76) Inventors: Yasuto Kuroda, Saitama-shi (JP); Hironobu Kayano, Saitama-shi (JP)

Correspondence Address: BIRCH STEWART KOLASCH & BIRCH, PO BOX 747, FALLS CHURCH, VA, 22040-0747, US

(21) Appl. No.: 12/822,363

(22) Filed: Jun. 24, 2010

(30) Foreign Application Priority Data
Jul. 3, 2009 (JP) P2009-158859

(51) Int. Cl. G03B 21/14; G02B 7/02

(52) U.S. Cl. 353/101; 359/813

(57) ABSTRACT

Disclosed is a technique that prevents the inclination of a lens barrel in a downward direction and does not hinder a reduction in size.

A pair of sliding portions that slides along slide shafts is provided on both sides of a plate-shaped flange in which an opening for attaching a lens barrel is provided. The sliding portions are formed at different heights. Circular through holes through which the columnar slide shafts pass are formed in the sliding portions to extend in the height direction. When the sliding portions slide along the slide shafts, the flange is shifted in the height direction. The lens barrel attached to the flange is shifted in the height direction together with the flange.

### CROSS-REFERENCE TO RELATED APPLICATIONS

This application is based upon and claims the benefit of priority from the Japanese Patent Application No. 2009-158859 filed on Jul. 3, 2009; the entire contents of which are incorporated herein by reference.

### BACKGROUND OF THE INVENTION

1. Field of the Invention

The present invention relates to a lens barrel shift mechanism that shifts a lens barrel in a height direction and a projector including the same.

2. Description of the Related Art

A projector has been proposed which receives image signals from an electronic apparatus, such as a personal computer, and projects an image onto a screen. The projector includes a zoom lens that magnifies or reduces an image and a focus lens that adjusts focus. Each lens is provided in a lens barrel and is moved in the optical axis direction. One end of the lens barrel is attached to the flange, and the lens barrel can be shifted in the height direction of the flange. The lens barrel is shifted in the height direction to adjust the projection height of an image.

A shift mechanism for shifting the lens barrel includes a pair of slide shafts that is provided on both sides of the flange and extends in the height direction and sliding portions that are provided integrally with the flange and slide along the slide shafts. The sliding portions each have a through hole formed in the height direction, and the slide shafts are fitted to the through holes. When the sliding portions slide along the slide shafts, the shift mechanism shifts the lens barrel in the height direction.

A small gap is formed between the through hole and the slide shaft such that the slide shaft slides through the through hole. The gap causes the lens barrel to be inclined due to the weight of the lens barrel, which results in the distortion of a projection image. Therefore, it is necessary to prevent the inclination of the lens barrel.

Japanese Patent No. 3936360 discloses a projector that includes a spring which elastically presses a lens barrel from the lower side and prevents the inclination of the lens barrel.

The projector can be provided in various ways. For example, the projector is provided on the desk or the ceiling with the upside down 180°. However, in Japanese Patent No. 3936360, only the case in which the projector is provided on the desk is assumed. For example, when the projector is used with the upside down, it is difficult to prevent the inclination of the lens barrel.

However, when the maximum value of the gap between the through hole and the slide shaft is a and the length of the through hole is b, the inclination of the lens barrel is represented by tan⁻¹(a/b). Therefore, it is possible to prevent the inclination of the lens barrel by increasing the length of the through hole. However, it is preferable that the through hole be short in terms of coaxiality with respect to the slide shaft. When the length of the through hole is increased, it is necessary to increase the length of the slide shaft by a value corresponding to the increment, which prevents the size of the shift mechanism from being reduced. Therefore, it is preferable to prevent the inclination of the lens barrel without increasing the length of the through hole.

### SUMMARY OF THE INVENTION

The invention has been made in view of the above, and one embodiment of the invention provides a small lens barrel shift mechanism capable of preventing the inclination of a lens barrel in a downward direction and a projector having the same.

According to an aspect of the invention, a lens barrel shift mechanism includes a flange, a pair of slide shafts and a pair of sliding portions. A lens barrel is attached to the flange. The pair of slide shafts is provided on both sides of the flange and extends in a height direction. The pair of sliding portions is provided integrally with the flange, is fitted to the pair of slide shafts on both sides of the flange at different heights, and slides along the slide shafts.

Each of the sliding portions may have a through hole extending in the height direction. The slide shafts may be fitted to the through holes. The slide shaft may have a columnar shape or a cylindrical shape.

According to another aspect of the invention, a projector includes the lens barrel shift mechanism according to the above-mentioned aspect.

In the lens barrel shift mechanism and the projector according to the above-mentioned aspects of the invention, the pair of sliding portions is provided integrally with the flange on both sides thereof, and slides along the slide shafts that are provided on both sides of the flange. The sliding portions are fitted to the slide shafts at different heights. Therefore, it is possible to prevent the inclination of the lens barrel in the downward direction, as compared to the case where a pair of sliding portions is fitted to the slide shafts at the same height.

### BRIEF DESCRIPTION OF THE DRAWINGS

FIG. 1 is a perspective view illustrating the outward appearance of a projector;

FIG. 2 is a perspective view illustrating the outward appearance of a lens barrel and a shift mechanism;

FIG. 3A is a top view illustrating the shift mechanism having the lens barrel fixed thereto;

FIG. 3B is a front view illustrating the shift mechanism having the lens barrel fixed thereto;

FIG. 4A is a diagram illustrating a gap formed in a through hole and shows the upper surface of a sliding portion and the cross section of a slide shaft taken along the upper surface of the sliding portion; and

FIG. 4B is a diagram illustrating the gap formed in the through hole and shows the side of the slide shaft and the longitudinal section of the sliding portion taken along the through hole.

### DESCRIPTION OF THE PREFERRED EMBODIMENTS

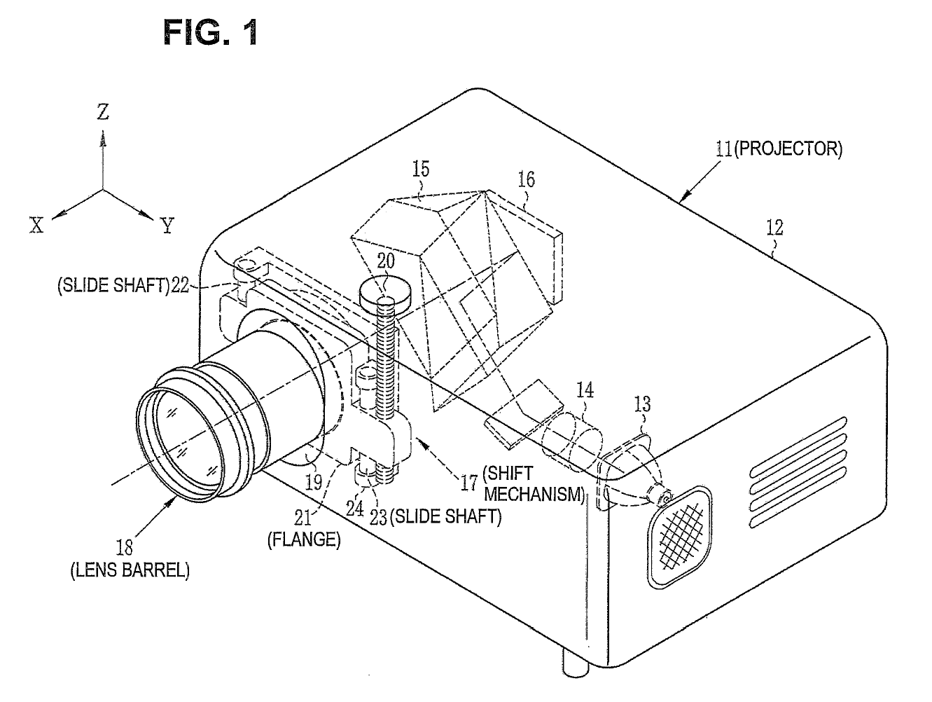

Hereinafter, a projector 11 using a lens barrel shift mechanism according to an embodiment of the invention will be described. The projector 11 shown in FIG. 1 includes a light source 13, an illumination optical system 14, a total reflecting prism 15, a digital micro mirror device (hereinafter, referred to as a DMD) 16, and a shift mechanism 17 which are provided in a housing 12 with a substantially rectangular parallelepiped shape.

A lens barrel 18 attached to the shift mechanism 17 protrudes forward (in the X-axis direction in FIG. 1) from an opening (not shown) that is formed in the front surface of the housing 12. A light shielding plate 19 is provided inside the opening so as to cover the opening. The lens barrel 18 is shifted in the height direction (in the Z-axis direction in FIG. 1) by the shift mechanism 17, and the light shielding plate 19 slides when the lens barrel 18 is shifted. A shift knob 20 of the shift mechanism 17 is provided on the upper surface of the housing 12. The user rotates the shift knob 20 to shift the lens barrel 18.

The light source 13 emits light to the illumination optical system 14. The illumination optical system 14 includes, for example, a color filter or an integrator and transmits light emitted from the light source 13 to be incident on the total reflecting prism 15. The total reflecting prism 15 reflects the light incident from the illumination optical system 14 to the DMD 16.

The light incident on the DMD 16 is reflected from the DMD 16 to change into display light of the image displayed on the DMD 16. The display light from the DMD 16 is projected onto, for example, a screen through the lens barrel 18. For example, a high-intensity discharge lamp, such as an ultra high pressure mercury lamp, a metal halide lamp, or a xenon lamp, is used as the light source 13. Since the illumination optical system 14, the total reflecting prism 15, and the DMD 16 have been known, a detailed description thereof will be omitted. The Y-axis is rotated 90° from the X-axis on the Z-axis. The X-axis, Y-axis, and Z-axis directions shown in FIG. 1 are the same as those in the drawings other than FIG. 1.

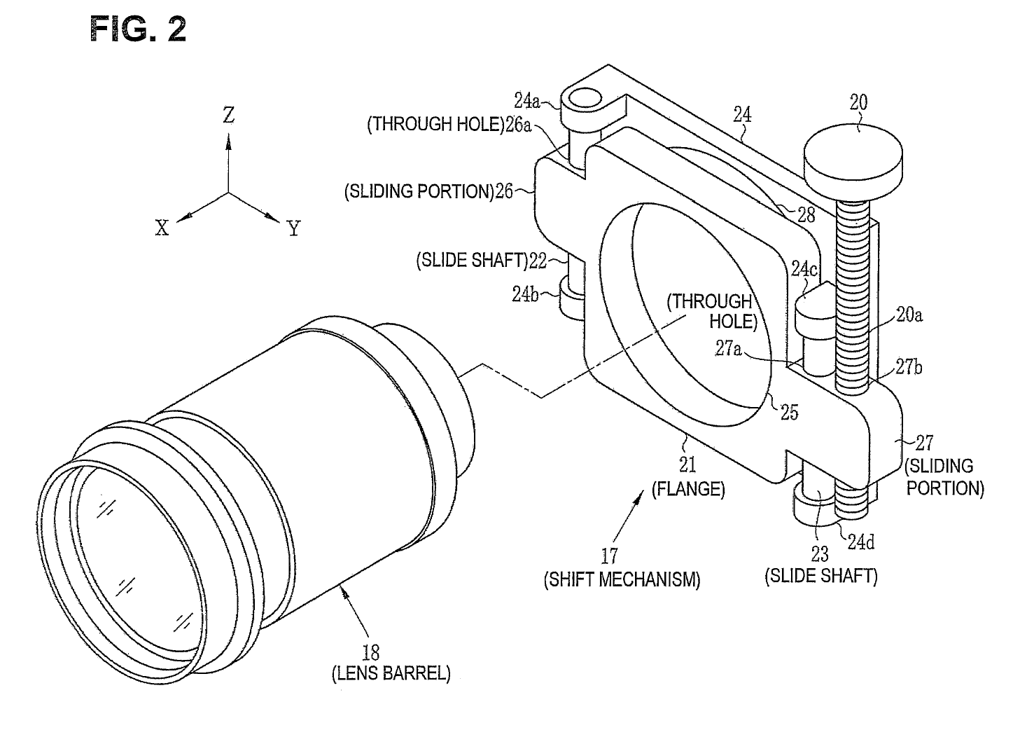

The shift mechanism 17 shown in FIG. 2 includes a plate-shaped flange 21 that fixes the lens barrel 18, a pair of slide shafts 22 and 23 that is provided on both sides of the flange 21 and extends in the height direction, a substrate 24 that fixes the slide shafts 22 and 23, the shift knob 20, and a lead screw 20a.

An opening 25 for attaching the lens barrel 18 is provided in the flange 21. The lens barrel 18 is fitted to the opening 25. A pair of sliding portions 26 and 27 that slides along the slide shafts 22 and 23 is provided on both sides of the flange 21. The sliding portions 26 and 27 with different heights are formed integrally with the flange 21.

Circular through holes 26a and 27a are formed in the sliding portions 26 and 27 to extend in the height direction, respectively, and the columnar slide shafts 22 and 23 pass through the circular through holes 26a and 27a, respectively. A screw hole 27b is formed in the sliding portion 27 in the height direction so as to be adjacent to the through hole 27a. The lead screw 20a is inserted into the screw hole 27b. The lead screw 20a is rotated with the rotation of the shift knob 20. When the lead screw 20a is rotated, the sliding portions 26 and 27 slide along the slide shafts 22 and 23 and the flange 21 is shifted in the height direction. The lens barrel 18 attached to the flange 21 is shifted in the height direction together with the flange 21.

Fixing portions 24a to 24d for fixing the slide shafts 22 and 23 are provided on the substrate 24. Both ends of each of the slide shafts 22 and 23 are supported by the fixing portions 24a to 24d and the slide shafts 22 and 23 are fixed to the substrate 24. The substrate 24 is fixed in the housing 12. An opening 28 for guiding the display light from the DMD 16 (see FIG. 1) to the lens barrel 18 is formed in the substrate 24.

A plurality of lenses (not shown) including, for example, a zoom lens that magnifies or reduces an image and a focus lens that adjusts focus are provided in the lens barrel 18. The display light passing through the lenses is projected as an image.

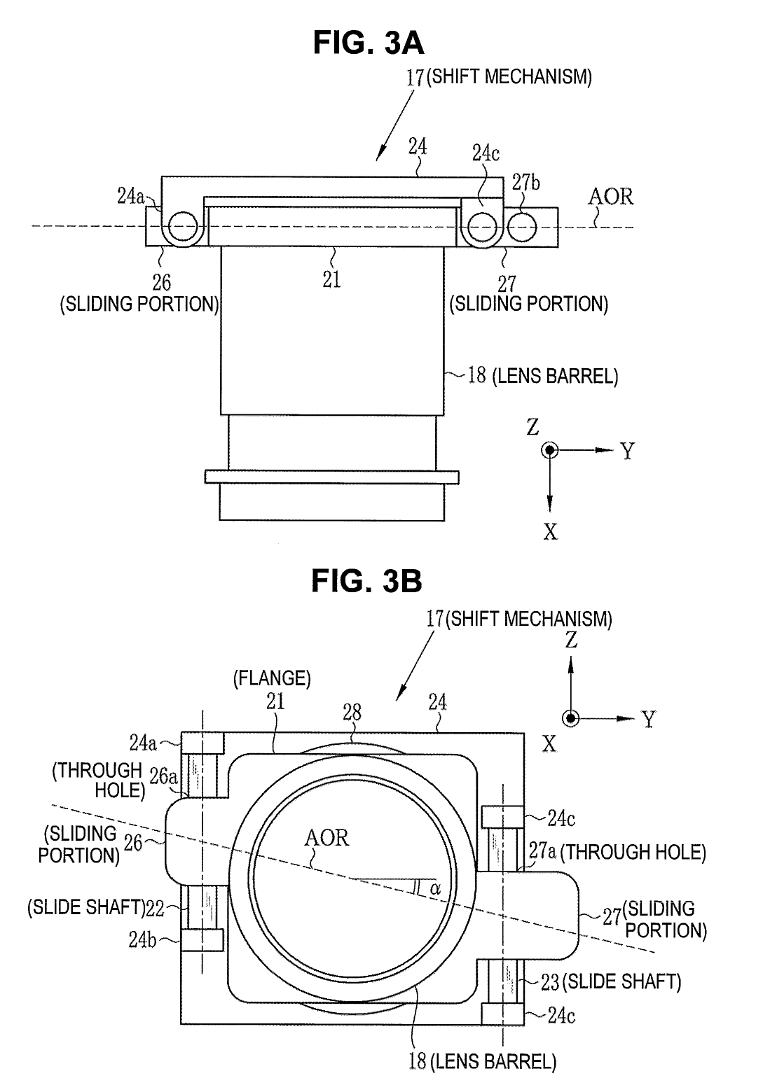

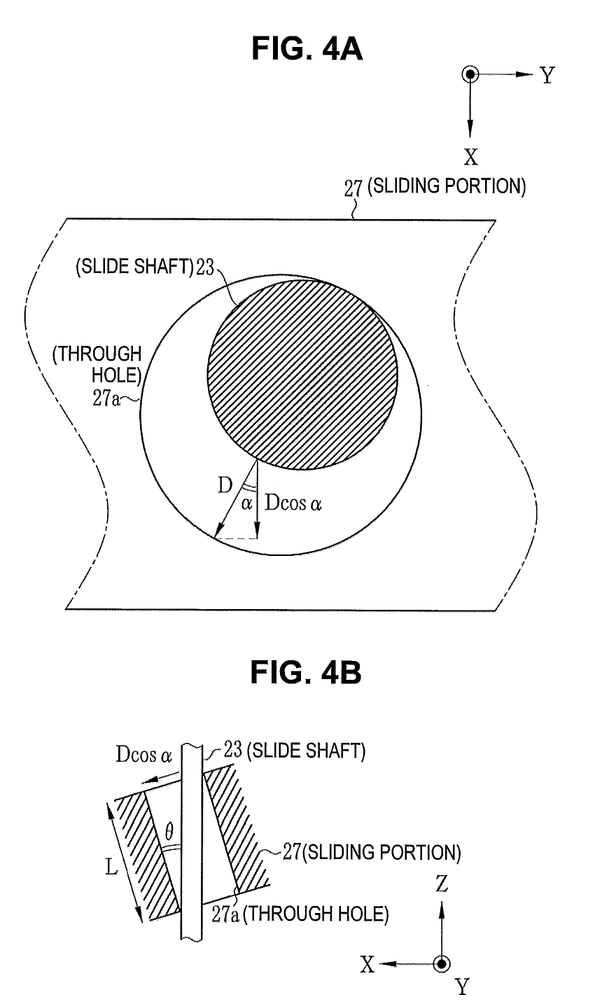

Next, the operation of the lens shift mechanism 17 will be described with reference to FIGS. 3A, 3B, 4A, and 4B. In FIGS. 3A and 3B, for simplicity, the shift knob 20 and the lead screw 20a are not shown.

There are small gaps between the through holes 26a and 27a and the slide shafts 22 and 23 such that the through holes 26a and 27a slide with respect to the slide shafts 22 and 23. The gaps cause the lens barrel 18 to be tilted downward due to the weight of the lens barrel 18. The lens barrel 18 is tilted in the direction in which the axis of rotation AOR linking the centers of the sliding portions 26 and 27 is rotated (see FIGS. 3A and 3B). The axis of rotation AOR is inclined in the horizontal direction (the Y-axis direction). In the following description, the inclination angle of the axis of rotation AOR in the horizontal direction is referred to as α.

The gaps between the through holes 26a and 27a and the slide shafts 22 and 23 are the maximum on the upper and lower surfaces of the sliding portions 26 and 27. The upper surface of the sliding portion 27 will be described as an example. As shown in FIG. 4A, the gap is the maximum in the direction that is inclined at an angle of α from the X-axis direction. For example, the maximum value D of the gap is equal to or less than 1 mm. However, for convenience of explanation, in FIGS. 4A and 4B, the gap is enlarged.

The inclination of the lens barrel 18 in the downward direction is defined by the tangent ratio between the maximum value of the gap in the X-axis direction and the length of the through holes 26a and 27a in the longitudinal direction. The maximum value of the gap in the X-axis direction is Dcosα, as shown in FIG. 4A. Therefore, when the length of the through holes 26a and 27a in the longitudinal direction is L as shown in FIG. 4B, the inclination θ of the lens barrel 18 in the downward direction is represented by tan⁻¹(Dcosα/L). θ=tan⁻¹ (Dcosα/L) is monotonically decreasing function when α is regarded as a variable. As α is decreased, θ is increased. As α is increased, θ is decreased.

As described above, when the sliding portions 26 and 27 are provided at different heights, it is possible to reduce the inclination of the lens barrel in the downward direction, as compared to when the sliding portions are provided at the same height. Specifically, it is possible to reduce the inclination of the lens barrel in the downward direction by tan⁻¹(D/L)−tan⁻¹(Dcosα/L). In the embodiment, it is assumed that the projector is used on, for example, the desk. However, the projector may be turned upside down. In this case, the same effects as described above are obtained.

The width of each of the sliding portions 26 and 27 in the height direction (the Z-axis direction) is less than that of the flange 21. Therefore, it is not necessary to increase the lengths of the slide shafts 22 and 23, and the size of the shift mechanism 17 is not increased.

In the embodiment, the sliding portions 26 and 27 are formed integrally with the flange 21. However, the sliding portions 26 and 27 may be formed integrally with or separately from the flange 21. In this case, the sliding portions are screwed to the flange 21.

In the embodiment, the slide shafts 22 and 23 have a columnar shape. However, the slide shafts 22 and 23 may be fitted to the through holes 26a and 27a and have a cylindrical shape. In the embodiment, the slide shafts 22 and 23 are fitted to the through holes 26a and 27a of the sliding portions 26 and 27, respectively. However, the slide shafts 22 and 23 may be fitted to grooves having a semicircular shape in a cross-sectional view.

In the embodiment, the lens barrel 18 is shifted only in the height direction. However, the lens barrel 18 may be configured so as to be also shifted in the left-right direction. In this case, a mechanism for shifting the substrate 24 in the left-right direction is provided. A pair of sliding portions is provided on both sides of the substrate 24 in the vertical direction, and the substrate 24 slides in the same way as that in which the lens barrel slides along the slide shafts 22 and 23. The sliding portions are formed integrally with the substrate 24 at different positions in the left-right direction. In this way, the lens barrel 18 can be obliquely inclined (to the left or right side) due to its weight. That is, it is possible to cancel the inclination of the lens barrel 18 in the left-right direction with the inclination of the lens barrel 18 by the shift mechanism 17.

What is claimed is:

1. A lens barrel shift mechanism comprising:
a flange to which a lens barrel is attached;
a pair of slide shafts that is provided on both sides of the flange and extends in a height direction; and
a pair of sliding portions that is provided integrally with the flange, is fitted to the pair of slide shafts on both sides of the flange at different heights, and slides along the slide shafts.

2. The lens barrel shift mechanism according to claim 1,
wherein each of the sliding portions has a through hole extending in the height direction, and
the slide shafts are fitted to the through holes.

3. The lens barrel shift mechanism according to claim 1,
wherein the slide shaft has a columnar shape or a cylindrical shape.

4. The lens barrel shift mechanism according to claim 2,
wherein the slide shaft has a columnar shape or a cylindrical shape.

5. A projector comprising the lens barrel shift mechanism according to claim 1.

6. A projector comprising the lens barrel shift mechanism according to claim 2.

7. A projector comprising the lens barrel shift mechanism according to claim 3.

8. A projector comprising the lens barrel shift mechanism according to claim 4.
